(19) United States
(12) Patent Application Publication
(10) Pub. No.: US 2020/0140118 A1
(43) Pub. Date: May 7, 2020

(54) METHOD AND APPARATUS FOR RECORDING FLIGHT LOG OF UNMANNED AERIAL VEHICLE, STORAGE MEDIUM AND COMPUTER DEVICE

(71) Applicant: Autel Robotics Co., Ltd., Shenzhen (CN)

(72) Inventors: Shijun YU, Shenzhen (CN); Liang ZENG, Shenzhen (CN)

(21) Appl. No.: 16/727,110

(22) Filed: Dec. 26, 2019

Related U.S. Application Data
(63) Continuation of application No. PCT/CN2018/082216, filed on Apr. 8, 2018.

(30) Foreign Application Priority Data
Jun. 26, 2017 (CN) 201710495876.1

(51) Int. Cl. B64D 45/00; B64C 39/02; G07C 5/08; G07C 5/00; G08G 5/00; G05D 1/10; G06F 11/10; G06F 40/205; G06F 16/17

(52) U.S. Cl. CPC B64D 45/00; B64C 39/024; G07C 5/085; G07C 5/008; B64C 2201/127; G05D 1/101; G06F 11/1004; G06F 40/205; G06F 16/1734; G08G 5/003

(57) ABSTRACT

The present invention relates to a method and an apparatus for recording a flight log of an unmanned aerial vehicle (UAV), a storage medium and a computer device. A log message is generated, the log message is stored in a message storage area, and a buffer area obtains the log message in the message storage area. The log message buffered in the buffer area is written into a memory card when the log message buffered in the buffer area meets any of the following conditions. The conditions include: the log message buffered in the buffer area occupies a storage capacity that reaches a capacity threshold or the log message is buffered in the buffer area for a number of times that reaches a threshold number of times. Each log message is generated independently and each generated log message is written into the buffer area. The event trigger mechanism has good real-time performance and can effectively reduce a probability of log message loss. In addition, a storage space can be released for the buffer area in time, thereby effectively avoiding log message loss caused by untimely writing of the log message as a result of an insufficient storage space in the buffer area.

### CROSS-REFERENCE

This application is a continuation of PCT/CN2018/082216 filed on Apr. 8, 2018, which claims priority to Chinese Patent Application No. 201710495876.1 filed on Jun. 26, 2017, both of which are incorporated by reference in their entireties.

### BACKGROUND

### Technical Field

The present invention relates to the technical field of unmanned aerial vehicles (UAV), and in particular, to a method and an apparatus for recording a flight log of a UAV, a storage medium and a computer device.

### Related Art

In a flight log of a UAV, various flight data during flight of the UAV is generally recorded, including a flight attitude, a flight trajectory, data detected by a sensor, a flight speed, a flight altitude and a flight direction, etc. A flight log plays an important role in flight testing, data analysis and trajectory monitoring of a UAV, and is an essential part of a UAV system. All present methods for recording a flight log of a UAV have some disadvantages, for example, data loss as a result of slow writing of data into a secure digital memory card (SD card), inconvenience in analysis of data in a log record and lack of checking on content in a log record. Therefore, a flight log recording method needs to be provided to resolve the foregoing problems.

### SUMMARY

Based on the above, a method and an apparatus for recording a flight log of a UAV, a storage medium and a computer device need to be provided to effectively avoid loss of data in a flight log of a UAV.

A method for recording a flight log of a UAV is provided, including:

generating a log message;

storing the log message in a message storage area;

obtaining, by a buffer area, the log message in the message storage area; and

writing the log message buffered in the buffer area into a memory card when the log message buffered in the buffer area meets any of the following conditions:

the log message buffered in the buffer area occupies a storage capacity that reaches a capacity threshold; or

the log message is buffered in the buffer area for a number of times that reaches a threshold number of times.

In an embodiment, the log message includes: a format portion, a mark portion and a message body, where

the message body includes a message header portion, a message identification portion, a message length portion, a message content portion and a message check portion, the message identification portion being used to record a category of the log message, and the message check portion being used to check the log message;

the format portion being used to define a format of the message content portion; and

the mark portion being used to distinguish between the log messages.

In an embodiment, in the mark portion, a coordinated universal time (UTC) or an incremental log file name is adopted to distinguish between the log messages.

In an embodiment, the method further includes: parsing the message body.

In an embodiment, the parsing the message body includes:

checking the message header portion in the message body of the log message;

obtaining the message identification portion, the message length portion, the message content portion and the message check portion in the message body if the checking succeeds; and

checking the message content portion according to the message check portion, the message body being successfully parsed if the checking succeeds.

In an embodiment, the message header portion includes two synchronization words.

In an embodiment, the message content portion is checked through cyclic redundancy check (CRC).

A computer device is provided, including a memory, a processor and a computer program stored in the memory and executable on the processor. When the processor executes the computer program, the foregoing method is implemented.

An apparatus for recording a flight log of a UAV is provided, including:

a log message generating module configured to generate a log message;

a storage area configured to store the log message generated by the log message generating module;

a buffer area configured to extract the latest log message in a storage area; and

a memory card writing module configured to write the log message buffered in the buffer area into a memory card when the log message buffered in the buffer area meets any of the following conditions: the log message buffered in the buffer area occupies a storage capacity that reaches a capacity threshold; or

the log message is buffered in the buffer area for a number of times that reaches a threshold number of times.

In an embodiment, the log message includes: a format portion, a mark portion and a message body, where

the message body includes a message header portion, a message identification portion, a message length portion, a message content portion and a message check portion, the message identification portion being used to record a category of the log message, and the message check portion being used to check the log message;

the format portion being used to define a format of the message content portion; and

the mark portion being used to distinguish between the log messages.

In an embodiment, in the mark portion, a coordinated universal time (UTC) or an incremental log file name is adopted to distinguish between the log messages.

A computer readable storage medium storing a computer program is provided, and when the program is executed by a processor, the following steps are implemented:

generating a log message;

storing the log message in a storage area;

obtaining, by a buffer area, the log message in the storage area; and

writing the log message buffered in the buffer area into a memory card when the log message buffered in the buffer area meets any of the following conditions:

the log message buffered in the buffer area occupies a storage capacity that reaches a capacity threshold; or

the log message is buffered in the buffer area for a number of times that reaches a threshold number of times.

Each log message of the present invention is independently generated. When the log message buffered in the buffer area meets any of the conditions, that is, when the buffered log message occupies the storage capacity that reaches the capacity threshold or the log message is buffered for the number of times that reaches the threshold number of times, the log message buffered in the buffer area is written into the memory card. The write condition adopts the event trigger mechanism, so that the log message is recorded in real-time, and log message loss caused by untimely writing of a log message as a result of an insufficient storage space in the buffer area can be avoided, thereby effectively reducing a probability of log message loss.

### BRIEF DESCRIPTION OF THE DRAWINGS

FIG. 1 is a principle diagram of a method for recording a flight log of a UAV according to an embodiment of the present invention;

FIG. 2 is a flowchart of a method for recording a flight log of a UAV according to an embodiment of the present invention;

FIG. 3 is a schematic structural diagram of a log message of a UAV according to an embodiment of the present invention;

FIG. 4 is a schematic structural diagram of a message body in FIG. 3;

FIG. 5 is a flowchart of a method for recording a flight log of a UAV according to an embodiment of the present invention;

FIG. 6 is a flowchart of a method for recording a flight log of a UAV according to an embodiment of the present invention;

FIG. 7 is a flowchart of parsing a flight log of a UAV according to an embodiment of the present invention; and

FIG. 8 is a schematic structural diagram of an apparatus for recording a flight log of a UAV according to an embodiment of the present invention.

### DETAILED DESCRIPTION

To make the objectives, features and advantages of the present invention more comprehensible, specific embodiments of the present invention are described in detail below with reference to the accompanying drawings. Many specific details are described below for a full understanding of the present invention. However, the present invention may be implemented in many other ways than that described herein. Those skilled in the art may make similar improvements without departing from the essence of the present invention, so that the present invention is not limited to the specific embodiments disclosed below.

Unless otherwise defined, meanings of all technical and scientific terms used in this specification are the same as that usually understood by a person skilled in the technical field to which the present invention belongs. In this specification, terms used in the specification of the present invention are merely intended to describe objectives of the specific embodiments, but are not intended to limit the present invention. The technical features in the foregoing embodiments may be randomly combined. For concise description, not all possible combinations of the technical features in the embodiment are described. However, the combinations of the technical features should all be considered as falling within the scope described in this specification provided that they do not conflict with each other.

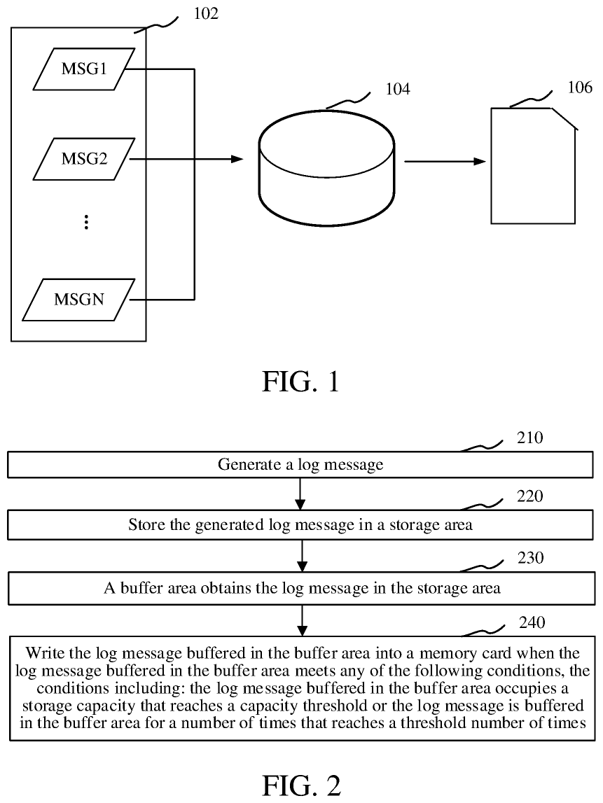

FIG. 1 is a principle diagram of a method for recording a flight log of a UAV according to an embodiment of the present invention. Referring to FIG. 1, a UAV generates a flight log during flight. The flight log includes a specific log message (MSG). Each generated log message is written into a storage area 102. A buffer area (BUF) 104 extracts a latest log message in the storage area 102. When the log message buffered in the buffer area 104 meets a write condition, the log message buffered in the buffer area 104 is written into a memory card 106. The memory card 106 is preferably an SD card.

As shown in FIG. 2, an embodiment of the present invention provides a method for recording a flight log of a UAV, including the following steps.

Step 210: A log message is generated.

During flight, a UAV generates a flight log for recording various flight data of the UAV during flight. The flight log includes a specific log message. The flight data includes a flight attitude, a flight trajectory, data detected by a sensor, a flight speed, a flight altitude, a flight direction and battery information, etc. The flight log message may also be generated by a flight control chip or other chips of the UAV.

Step 220: The generated log message is stored in the storage area 102. The storage area 102 may be an area specially developed for storing a log message, or may be an external storage device.

Therefore, all generated log messages are first stored in the storage area 102, so that flight data can be prevented from being lost as a result of a slow processing speed of the buffer area 104 when the generated log messages continuously enter the buffer area 104.

Step 230: The buffer area 104 obtains the log message in the storage area 102.

In an optional embodiment of the present invention, the buffer area 104 may actively or passively obtain a latest log message in the storage area 102. In particular, when there is a latest log message in the storage area 102, the buffer area 104 actively extracts the latest log message in the storage area 102. Alternatively, when there is a latest log message in the storage area 102, the storage area 102 pushes the latest log message to the buffer area 104 according to a present log message processing capability of the buffer area 104.

Step 240: The log message buffered in the buffer area is written into a memory card when the log message buffered in the buffer area meets any of the following conditions. The conditions include: the log message buffered in the buffer area occupies a storage capacity that reaches a capacity threshold or the log message is buffered in the buffer area for a number of times that reaches a threshold number of times.

When the log message buffered in the buffer area occupies the storage capacity that reaches a specific percentage of a total capacity of the buffer area, for example, reaches two-thirds of the total capacity of the buffer area, the log message buffered in the buffer area is written into the memory card. Alternatively, when the log message is buffered in the buffer area for the number of times that reaches the threshold number of times, for example, the log message is buffered 100 times, the log message buffered in the buffer area is written into the memory card.

The memory card includes a compact flash (CF) card, a smart media (SM) card, a solid state floppy disk card and an SD card, etc. Preferably, in this embodiment of the present invention, the SD card may be used to store data.

The SD card is a new-generation memory device based on a semiconductor flash memory. Due to a small size, a fast data transfer speed and a hot-pluggable feature, etc., the SD card is widely used on portable apparatuses, such as a digital camera, a personal digital assistant (PDA) and a multimedia player, etc.

In this embodiment, each log message is generated independently, and the generated log message is first stored in the storage area to prevent flight data from being lost as a result of a slow processing speed of the buffer area. In addition, the generated log message is written into the memory card when meeting any of the conditions. The event trigger mechanism has good real-time performance and can effectively reduce a probability of log message loss. In addition, a storage space can be released for the buffer area in time, thereby effectively avoiding log message loss caused by an insufficient processing capacity of the buffer area.

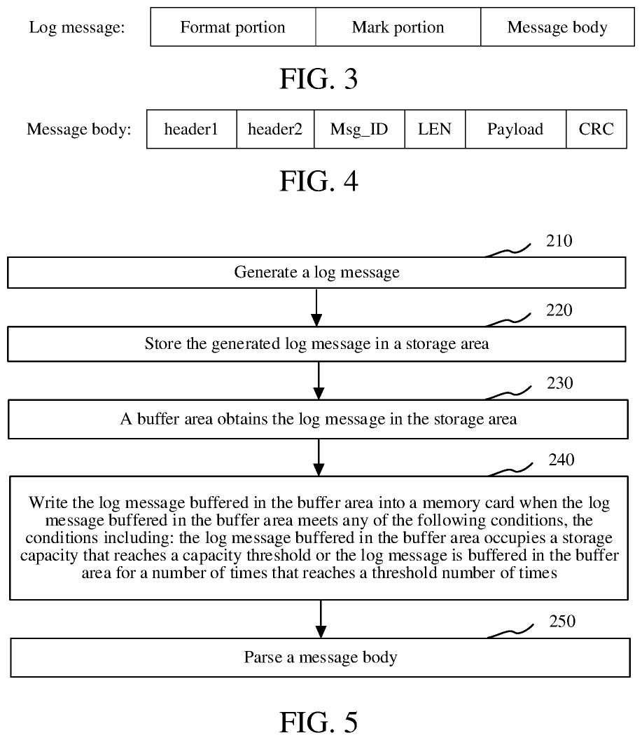

As shown in FIG. 3, in an embodiment provided in the present invention, the log message includes: a format portion, a mark portion and a message body.

The mark portion is used to distinguish between generated log messages. In an embodiment of the present invention, each log message records a UTC generated by the log message, and the UTC is used to distinguish between log messages generated at different times, which is convenient for subsequent data analysis on the log messages. Alternatively, an incremental log file name is adopted to distinguish between the log messages, for example, the log messages are distinguished by using LOG1, LOG2, . . . , and LOGN. The log messages may also be distinguished in the two manners to prevent a failure to record the UTC due to a GPS failure.

Referring to FIG. 4, the message body includes a message header portion (a header1 and a header2), a message identification portion (Msg_ID), a message length portion (LEN), a message content portion (Payload) and a message check portion (CRC).

The message header portion adopts a double-header structure: a header1 and a header2.

The message header portion is used to mark a start location of each log message. The double-header structure consumes fewer resources and can improve recognition of subsequently parsing the log message.

The message identification portion is MessageID and is used to record a category of the log message. For example, if MessageID (Msg_ID) is battery, it indicates that the log message records battery information, and the category of the log message is battery.

The message length portion (LEN) is used to record a length of the log message.

The message content portion (Payload) is actual flight data, such as GPS data, a location and a status.

The message check portion is used to check the log message. Generally, CRC is adopted to check validity of the log message. CRC is the most common error check code in the field of data communication, which is characterized in that lengths of an information field and a check field may be arbitrarily selected.

The format portion is used to define a format of message content, the format of the message content being modified or redefined through the format portion. The format portion may customize content specifically recorded in the message content portion in the message body. If Msg_ID is battery, the message content portion may be customized to record power information and life information of the battery, or only the power information. The message content portion records the log message according to a data structure defined by the format portion.

For example, if the format portion defines a format of a log message about a battery, including a present power, a present voltage and a present current, the message content portion correspondingly records these pieces of information. Certainly, the format portion also supports customizing a format of the message content portion to record other information of the battery. The following is a code for the format portion of the log message of the battery, which defines the format of the message content portion in the message body:

| typedef struct { | |
|---|---|
| uint16_t | Capacity; |
| int16_t | Voltage; |
| int16_t | Current; |
| uint32_t | Timestamp_ms; |

} bat_status.

Capacity is the present power of the battery, Voltage is the present voltage of the battery, Current is the present current of the battery, and Timestamp_ms is a time stamp that records a present time.

In the embodiment provided in the present invention, the log message uniformly includes three portions: the format portion, the mark portion and the message body, the format portion being used to customize the format of the message content portion in the message body and to modify and redefine the customized format. Because each log message includes the foregoing three portions, the log message can be parsed according to a unified parsing method, thereby improving efficiency.

Based on the above, as shown in FIG. 5, the method may further include:

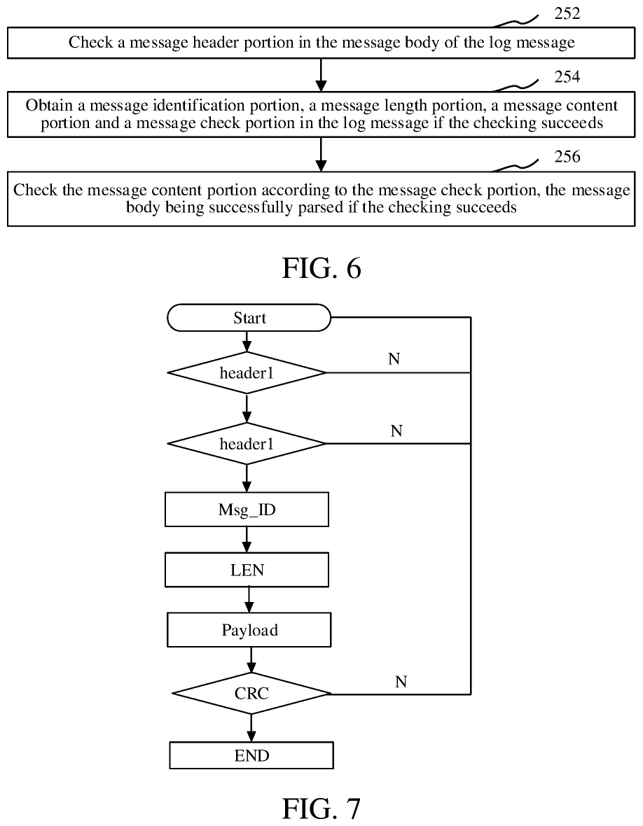

Step 250: The message body is parsed. As shown in FIG. 6, in an embodiment provided in the present invention, step 250 may further include the following step:

Step 252: The message header portion in the message body of the log message is checked.

FIG. 7 is a flowchart of parsing a message body according to an embodiment of the present invention. The message header portion is a double-header structure. For example, header1 is 163, and header2 is 169, 163 and 169 being synchronization words. The message header is checked to find a start of each log message and a start of each frame of data.

Step 254: The message identification portion, the message length portion, the message content portion and the message check portion in the log message are obtained if the checking succeeds.

If synchronization word checking fails, synchronization word checking is performed again on the message header portion.

Step 256: The message content portion is checked according to the message check portion, the message body being successfully parsed if the checking succeeds.

CRC is performed on content of the payload in the message body according to the message check portion, the log message being successfully parsed if the CRC succeeds. It indicates that the log message is complete and valid, and the log message may be used for subsequent message analysis. The CRC is added, so that a problem that integrity and validity of the log message are not checked in a traditional flight log recording method can be resolved.

In this embodiment, each log message stored in the memory card is parsed to select a complete and valid log message and discard an invalid log message. In this way, subsequent data analysis on the selected log message is facilitated to analyze a flight attitude, a flight trajectory, data detected by a sensor, a flight speed, a flight altitude, a flight direction and battery information, etc. of the UAV.

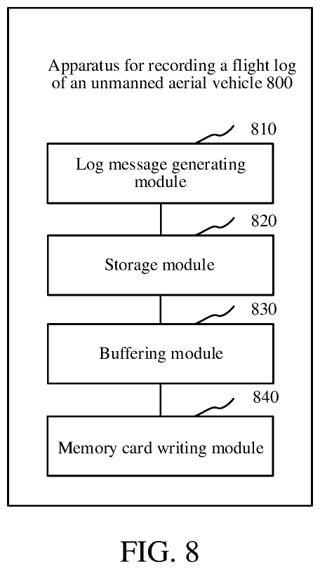

As shown in FIG. 8, an embodiment of the present invention further provides an apparatus 800 for recording a flight log of a UAV, including:

a log message generating module 810 configured to generate a log message;

a storage module 820 configured to store the log message generated by the log message generating module;

a buffering module 830 configured to extract the latest log message in a storage area; and

a memory card writing module 840 configured to write the log message buffered in the buffer area into a memory card when the log message buffered in the buffer area meets any of the following conditions, the write conditions including: the log message buffered in the buffer area occupies a storage capacity that reaches a capacity threshold or the log message is buffered in the buffer area for a number of times that reaches a threshold number of times.

In an embodiment, the log message includes: a format portion, a mark portion and a message body.

The format portion is used to define a format of the message content portion, and the mark portion is used to distinguish between the log messages. The message body includes a message header portion, a message identification portion, a message length portion, a message content portion and a message check portion, the message identification portion being used to record a category of the log message, and the message check portion being used to check the log message.

An embodiment of the present invention further provides a computer readable storage medium storing a computer program, and when the program is executed by a processor, the following steps are implemented:

generating a log message;

storing the log message in a storage area;

obtaining, by a buffer area, the log message in the storage area; and writing the log message buffered in the buffer area into a memory card when the log message buffered in the buffer area meets any of the following conditions. The conditions include: the log message buffered in the buffer area occupies a storage capacity that reaches a capacity threshold; or the log message is buffered in the buffer area for a number of times that reaches a threshold number of times.

In an embodiment, when the program is executed by the processor, the following step is further implemented: the format portion is used to define a format of the message content portion; and the mark portion is used to distinguish between the log messages. The message body includes a message header portion, a message identification portion, a message length portion, a message content portion and a message check portion, the message identification portion being used to record a category of the log message, and the message check portion being used to check the log message.

In an embodiment, when the program is executed by the processor, the following step is further implemented: a UTC or an incremental log file name is adopted to distinguish between the log messages in the mark portion.

In an embodiment, when the program is executed by the processor, the following step is further implemented: the message body is parsed.

In an embodiment, when the program is executed by the processor, the following step is further implemented: the parsing the message body includes: checking the message header portion in the message body of the log message; obtaining the message identification portion, the message length portion, the message content portion and the message check portion in the message body if the checking succeeds; and checking the message content portion according to the message check portion, the message body being successfully parsed if the checking succeeds.

In an embodiment, when the program is executed by the processor, the following step is further implemented: the message header portion includes two synchronization words.

In an embodiment, when the program is executed by the processor, the following step is further implemented: the message content portion is checked through CRC.

An embodiment of the present invention further provides a computer device, including a memory, a processor and a computer program stored in the memory and executable on the processor. When the processor executes the computer program, the following steps are implemented.

generating a log message;

storing the log message in a storage area;

obtaining, by a buffer area, the log message in the storage area; and writing the log message buffered in the buffer area into a memory card when the log message buffered in the buffer area meets any of the following write conditions. The write conditions include: the log message buffered in the buffer area occupies a storage capacity that reaches a capacity threshold; or the log message is buffered in the buffer area for a number of times that reaches a threshold number of times.

In an embodiment, when the processor executes the computer program, the following step is further implemented: the format portion is used to define a format of the message content portion; and the mark portion is used to distinguish between the log messages. The message body includes a message header portion, a message identification portion, a message length portion, a message content portion and a message check portion, the message identification portion being used to record a category of the log message, and the message check portion being used to check the log message.

In an embodiment, when the program is executed by the processor, the following step is further implemented: a UTC or an incremental log file name is adopted to distinguish between the log messages in the mark portion.

In an embodiment, when the processor executes the computer program, the following step is further implemented: the message body is parsed.

In an embodiment, when the processor executes the computer program, the following step is further implemented: the parsing the message body includes: checking the message header portion in the message body of the log message; obtaining the message identification portion, the message length portion, the message content portion and the message check portion in the message body if the checking succeeds; and checking the message content portion according to the message check portion, the message body being successfully parsed if the checking succeeds.

In an embodiment, when the processor executes the computer program, the following step is further implemented: the message header portion includes two synchronization words.

In an embodiment, when the processor executes the computer program, the following step is further implemented: the message content portion is checked through CRC.

The foregoing embodiments only describe several implementations of the present invention, and their description is specific and detailed, but cannot therefore be understood as a limitation to the patent scope of the present invention. It should be noted that, a person of ordinary skill in the art may make various changes and improvements without departing from the ideas of the present invention, which shall fall within the protection scope of the present invention. Therefore, the protection scope of the patent of the present invention shall be subject to the appended claims.

What is claimed is:

1. A method for recording a flight log of an unmanned aerial vehicle (UAV), comprising:
generating a log message;
storing the log message in a message storage area;
obtaining, by a buffer area, the log message in the message storage area; and
writing the log message buffered in the buffer area into a memory card when the log message buffered in the buffer area meets any of the following conditions:
the log message buffered in the buffer area occupies a storage capacity that reaches a capacity threshold; or
the log message is buffered in the buffer area for a number of times that reaches a threshold number of times.

2. The method according to claim 1, wherein the log message comprises: a format portion, a mark portion and a message body, wherein
the message body comprises a message header portion, a message identification portion, a message length portion, a message content portion and a message check portion, the message identification portion being used to record a category of the log message, and the message check portion being used to check the log message;
the format portion being used to define a format of the message content portion; and
the mark portion being used to distinguish between the log messages.

3. The method according to claim 2, wherein a coordinated universal time (UTC) or an incremental log file name is adopted to distinguish between the log messages in the mark portion.

4. The method according to claim 2, wherein the method further comprises:
parsing the message body.

5. The method according to claim 4, wherein the parsing the message body comprises:
checking the message header portion in the message body of the log message;
obtaining the message identification portion, the message length portion, the message content portion and the message check portion in the message body if the checking succeeds; and
checking the message content portion according to the message check portion, the message body being successfully parsed if the checking succeeds.

6. The method according to claim 5, wherein the message header portion comprises two synchronization words.

7. The method according to claim 5, wherein the message content portion is checked through cyclic redundancy check (CRC).

8. A computer device, comprising:
a processor; and
a memory storing a computer program, wherein the computer program is executable on the processor, wherein when the processor executes the computer program, the processor is configured to implement the method as claimed in claim 1.

9. A computer readable storage medium storing a program, wherein when the program is executed by a processor, the following steps are implemented:
generating a log message;
storing the log message in a storage area;
obtaining, by a buffer area, the log message in the storage area; and
writing the log message buffered in the buffer area into a memory card when the log message buffered in the buffer area meets any of the following conditions:
the log message buffered in the buffer area occupies a storage capacity that reaches a capacity threshold; or
the log message is buffered in the buffer area for a number of times that reaches a threshold number of times.
